(19) United States
(12) Patent Application Publication
(10) Pub. No.: US 2011/0114403 A1
(43) Pub. Date: May 19, 2011

(54) POWERTRAIN FOR HYBRID VEHICLE

(76) Inventors: Simon A. Hauger, Nartberth, PA (US); Ronald A. Preiss, Philadelphia, PA (US); Gerald C. Dilossi, Blackwood, NJ (US); Ann Cohen, Philadelphia, PA (US)

(21) Appl. No.: 12/907,557

(22) Filed: Oct. 19, 2010

Related U.S. Application Data
(60) Provisional application No. 61/252,834, filed on Oct. 19, 2009.

(51) Int. Cl. B60K 6/48

(52) U.S. Cl. 180/65.25; 180/65.27; 903/903

(57) ABSTRACT

The invention encompasses a drivetrain or powertrain system including a unique, cost-effective, reliable means for creating a hybrid power system that utilizes a vehicle's stock manual transmission. The instant invention has the advantage of eliminating the cost and complexity of sophisticated transmissions, as well as replacing the vehicles starter and alternator. These basic components result in a cost effective, efficient and reliable drive system.

This application claims the benefit of U.S. provisional patent application No. 61/252,834, which was filed on Oct. 19, 2009 and is incorporated herein by reference in its entirety.

### FIELD OF THE INVENTION

The invention encompasses a drivetrain or powertrain system including a unique, cost-effective, reliable means for creating a hybrid power system that utilizes a typical manual transmission or the vehicle's stock manual transmission. The instant invention has the advantage of eliminating the cost and complexity of sophisticated transmissions, significantly improving vehicle efficiency, and replacing the vehicles starter and alternator. These basic components result in a plug-in hybrid drive system that is cost effective, efficient and reliable.

### BACKGROUND OF THE INVENTION

Conventional hybrid vehicles are powered by an engine and one or more electric motor/generators, which in turn may be powered or energized by a rechargeable battery. In a charge-depleting mode, the battery is slowly allowed to discharge or drop to a minimum or threshold charge level over the course of travel, and may be recharged, for example, by using available energy from the engine output, the motor/generator, and/or by plugging the battery into an available energy source, such as an electrical outlet, when the vehicle reaches its destination.

During hybrid vehicle operation, a control method typically selects a preferred power source or combination of power sources (i.e., the engine and/or one or more motor/generators) in order to power the hybrid vehicle in an optimally fuel efficient manner. The control method also monitors battery charge level and schedules battery recharging in order to ensure the motor/generators remain operational to drive the hybrid vehicle. The battery is maintained in a charge-deleting or charge-sustaining mode. In general, a battery enters a charge-depleting mode when a control method selects the motor/generator as the preferred power source, such as while the vehicle is accelerating from a standstill, and draws energy from the battery, thereby depleting the battery charge. In a charge-sustaining mode, the battery is maintained at a particular charge level, preserving or sustaining the battery charge level.

The efficiency of a given control method or algorithm in managing the selection and/or combination of available hybrid power sources is affected by various external factors. For example, the distance of a vehicle trip or route, route topography, and the frequency of braking over the course of the route, each influence the vehicle speed profile over that route.

The inventors have invented a hybrid vehicle that is a parallel plug-in charge depleting gasoline-electric hybrid automobile that can be operated in charge depleting or charge sustaining mode.

### SUMMARY OF THE INVENTION

The invention encompasses a hybrid vehicle including an electric motor (e.g., Azure Dynamics electric motor) operating in parallel with a combustion engine (e.g., a Harley-Davidson combustion engine), and controlled using a data acquisition system (e.g., a Compaq RIO programmed in LabVIEW).

In certain embodiments, the invention encompasses a drive train for a hybrid vehicle, said hybrid vehicle including a generator adapted to be driven by an internal combustion engine and a vehicle-driving motor adapted to drive road wheels, and having a specific electric-power supply mode for supplying an alternating current generated by said generator comprising:

a current conversion device interposed in a current-conversion-device line electrically connecting said generator and said vehicle-driving motor, and adapted to be operated based on an electric power supplied from a battery so as to change an amplitude or a frequency of an alternating current generated by said generator;

required motor output determination unit adapted to determine a required output of said vehicle-driving motor in conformity to a required vehicle-driving force;

electric-power supply control unit adapted to determine a current waveform of an AC electric power to be supplied to said vehicle-driving motor, in conformity to said required output of said vehicle-driving motor, and controllably determine a strategy of how to supply said AC electric power; and wherein said electric-power supply control unit is operable, when there is a substantial waveform difference between a current waveform required for said vehicle-driving motor and a current waveform output from said generator, in said specific electric-power supply mode, to supply an AC electric power from said generator to said vehicle-driving motor via said current-conversion-device line so as to eliminate said waveform difference through said current conversion device, and, when there is no substantial waveform difference between said current waveforms and thereby an equilibrium waveform conversion is performed in said current conversion device, in said specific electric-power supply mode, to supply an AC electric power from said generator to said vehicle-driving motor via said bypass line without mediation of said current conversion device.

In certain illustrative embodiments, the system also uses an automated shifting device for the transmission. One of the unique aspects of this design is due to the electric motor and gas engine coupling design, it allows for the automation of the transmission. This allows an increase in efficiency and drivability, while using an inexpensive, stock transmission. In other illustrative embodiments, the automatic manual transmission is DSG or CVT. This design maintains the benefits of those transmissions, while being significantly less expensive, simpler, and lighter.

In certain illustrative embodiments, the hybrid vehicle is a parallel plug-in charge depleting gasoline-electric hybrid automobile. In various embodiments, the automobile can be operated in charge depleting or charge sustaining mode. In certain embodiments, charge depleting makes it a plug-in hybrid and further increases its fuel efficiency. In certain embodiments, the automobile is front wheel drive, rear wheel drive or four wheel drive. In another embodiment, the hybrid vehicle fuel system includes a removable fuel tank, an external fuel pump, a low pressure regulator, which are connected to an engine (e.g., a Harley-Davidson combustion engine).

The specific design allows for the control system to automate a stock manual transmission—turning an inexpensive, reliable manual transmission into an automated manual transmission.

In certain embodiments, a typical manual transmission through its single input shaft is powered by two power sources—an electric motor and an IC engine. In various embodiments, providing power from both the electric motor and IC engine to a single input shaft of the transmission is accomplished through a magnetic clutch that is controlled via the control system and a belt drive.

### BRIEF DESCRIPTION OF THE FIGURES

A more complete understanding of the invention may be obtained by reference to the accompanying drawings, when considered in conjunction with the subsequent detailed description. The embodiments illustrated in the drawings are intended only to exemplify the invention and should not be construed as limiting the invention to the illustrated embodiments, in which:

FIGS. 1a and 1b illustrate an illustrative two sample CAD renderings of the drive train and adapter plates.

FIG. 2 illustrates an illustrative electric mode simulation results used by the U.S. EPA federal test drive cycle.

FIG. 3 illustrates an illustrative cycle used for the U.S. EPA Commuter cycle, in which the distance was 2.9 miles with a maximum speed of 55 mph. There was gradual acceleration which peaked and held a constant speed until it quickly decelerated. The simulation displayed favorable results of 77.1 MPGe. The SOC plot shows that the electric motor was being used while the emissions plot proves that the gasoline engine was also integrated into the simulation.

FIGS. 4a and 4b illustrate an illustrative drive train layout top view (not complete) and an illustrative drive train layout side view (not complete).

FIGS. 5a-5c illustrate an illustrative prototype system built with both an electric motor and IC engine on the belt drive on a test bench.

FIGS. 6a-6d illustrate an illustrative prototype system built with both an electric motor and IC engine in a illustrative vehicle.

FIGS. 7a-7c illustrate illustrative Graphs of Battery Pack Data—The data supports the claims of the 78 MPGe and correlates to the 140 miles of driving.

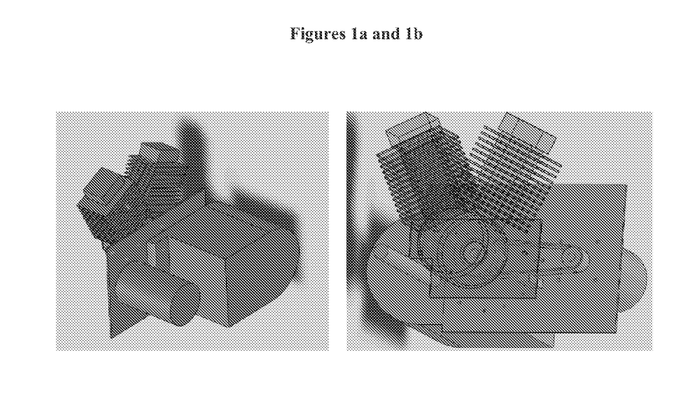

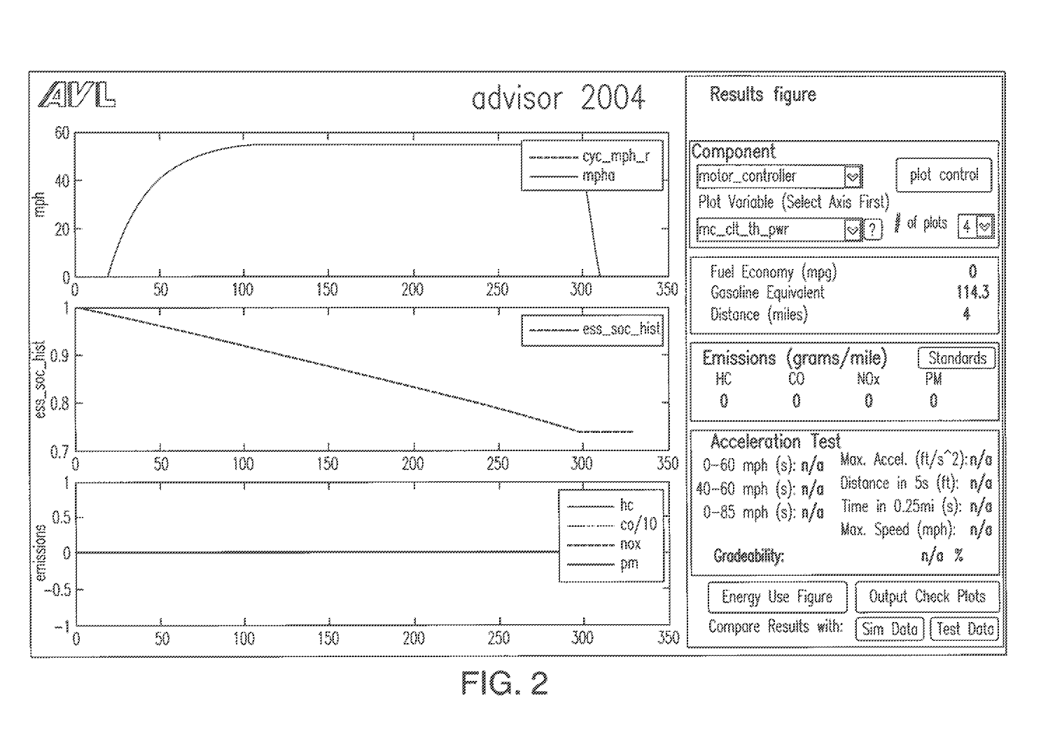

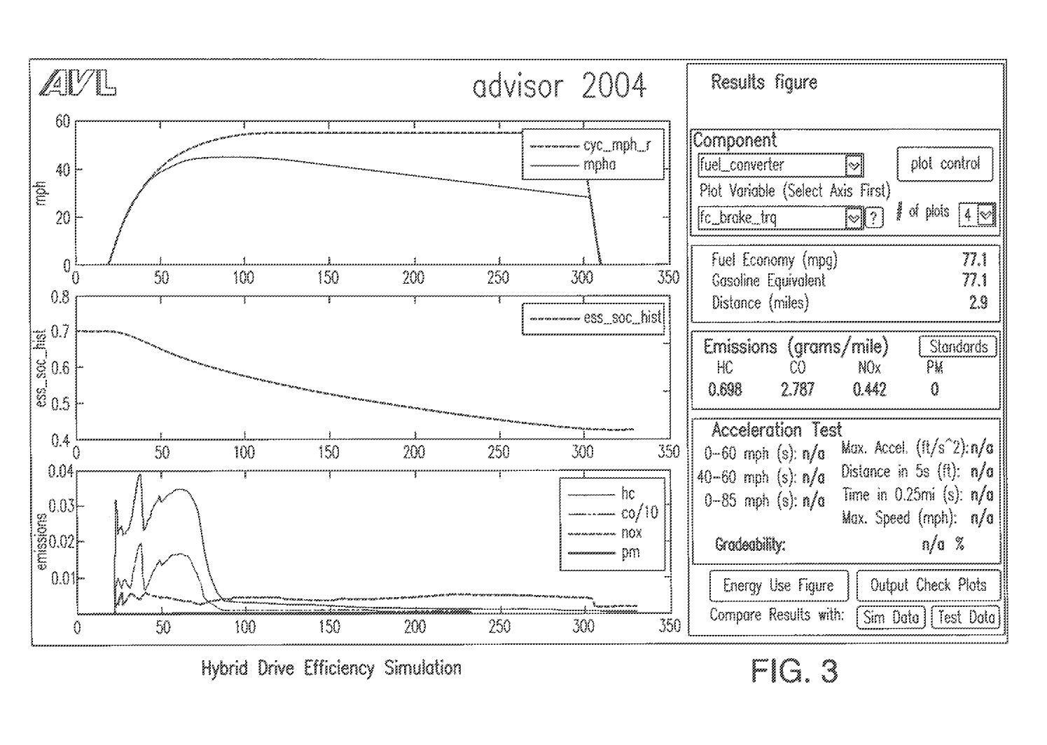

### DETAILED DESCRIPTION OF THE INVENTION

The invention encompasses a hybrid vehicle including an electric motor (e.g., Azure Dynamics electric motor) operating in parallel with a combustion engine (e.g., a Harley-Davidson combustion engine), controlled using a programmable microprocessor (e.g., a Compaq RIO programmed in LabVIEW).

In certain illustrative embodiments, the hybrid vehicle is a parallel plug-in gasoline-electric hybrid automobile. In certain embodiments, the automobile is front wheel drive, rear wheel drive or four wheel drive.

The prototype hybrid vehicle used to demonstrate this drive system includes an electric motor and motor controller powered by a battery pack (in the prototype, an Azure Dynamics motor, DMOC445 controller, and International Battery 15 kWh Lithium pack). In certain embodiments, the battery box is located in the trunk of the vehicle. In another embodiment, the motor and controller are located in the engine compartment of the vehicle.

As used herein, the “Azure Dynamics motor” refers to a motor with an optional gearbox with internal differential. In certain embodiments, this drive system is designed with front wheel compact sedans in mind. Vehicle conversions are fast and easy, because this motor/gearbox assembly will replace the engine and transmission of many compact front wheel drive vehicles. The motor includes DSP-based control, regenerative braking, space Vector PWM and Field Oriented Control, internal contactor with pre charge circuitry, lightweight aluminum chassis, waterproof, rugged construction, trenchgate IGBTs for maximum efficiency, over voltage and under voltage protection, three-level over current protection: 10 kHz DSP-based current control, analog over current watchdog, “Desat” protection at gate level; inverter over temperature protection, motor over temperature protection, over speed torque limit, diagnostics and data visualization via Controller Area Network (CAN) or RS232, CAN control with upper/lower torque limits and speed setpoint commands.

The drive train of the invention is a parallel plug-in hybrid drive system using reliable, cost-effective, available technology. The drive train utilizes the stock transmission, which is coupled to an Azure Dynamics AC24LS motor and a Harley-Davidson engine. The Azure motor and Harley engine are directly connected to the input shaft of the transmission via a belt pulley system. In certain embodiments, the shaft of the transmission is extended via a coupler to 1.125″ steel shaft through a bearing. In certain embodiments, the electric motor driven pulley is fixed to the shaft that extends into the magnetic clutch. In certain embodiments, the magnetic clutch couples the Harley-Davidson engine to the input shaft of the transmission. In certain embodiments, the electric motor is used to drive the vehicle, for regenerative braking, and replaces the starter for the Harley engine. In certain embodiments, the control system was developed in LabView running on a National Instruments Compact Rio. In certain embodiments, the control system coordinates engine and motor use to meet the driver's request (pedal position and driving mode selection) and to optimize the vehicle's efficiency. In other embodiments, the control system also automates the transmission selecting the ideal gear to optimize the vehicle's response and efficiency.

In certain embodiments, the crush zones, airbags, seats and seatbelts, vehicle stability, braking system, and tires have not and will not be modified. They all meet and will continue to meet FMVSS.

The hybrid vehicle achieves the required level of fuel economy by using the Azure Dynamics AC24LS electric motor as the primary drive. The two-cylinder HD engine is the secondary drive and is being tuned with an anticipated BSFC of 0.42 lbs/HP-hr. This combination enables the vehicle to meet fuel economy requirements. In certain embodiments, in an average daily commute of less than 50 miles, the hybrid vehicle will drive on electric only. In certain embodiments, the computed MPGe for this vehicle under those conditions is in the range of 150-180 MPGe.

In certain embodiments, the Battery Management System (BMS) provides continuous data to the control system monitoring the batteries temperature and voltage. In certain embodiments, the system displays this data for the driver's use and in the event that it reaches levels that are outside normal operating conditions, the control system turns the electric motor off and shuts down the high voltage system. In certain embodiments, the battery pack is also equipped with two 12 volt fans that meet the minimum requirement of 10 cfm. In certain embodiments, the pack will also have the required 9 centimeter diameter emergency outside port access as required by the rules.

In certain embodiments, the 200 lb battery pack at 40 G load results in an 8,000 lbs force on the box. That force over the area of fiberglass box in any direction is well less than the psi rating of the material of the box. In addition, the mounting hardware exceeds the requirements.

In another embodiment, the safety feature of the high voltage system is the battery chemistry. In certain embodiments, the chemistry and the specific brand of battery were chosen because of the safety record of these specific cells. In certain embodiments, this version of LiFePO is the safest on the market. In certain embodiments, the second potential safety concern is the removable fuel tank provided by PIAXP. In certain embodiments, the design challenge of integrating a removable fuel tank into an existing chassis lies in the way the chassis responds to a collision.

In certain embodiments, the hybrid vehicle is a parallel plug-in charge depleting hybrid vehicle. In typical driving in urban commuting the vehicle operates solely on electric power.

In certain embodiments, the hybrid vehicle includes a battery controller adapted to monitor an amount of electric power stored (i.e., storage amount) in the battery and control charging/discharging of the battery (i.e., charging/discharging of an electric power into/from the battery). In an operation of charging the battery, a part or entirety of an AC electric power generated by the generator is lead to the inverter/converter through the matrix converter. The AC electric power is converted to a DC electric power having a specified voltage through the inverter/converter and then introduced into the battery. In an operation of discharging the battery, the stored DC electric power is converted to an AC electric power having an optimal alternating current waveform through the inverter/converter, and then the AC electric power is supplied to the vehicle-driving motor through the matrix converter.

The vehicle-driving motor is an AC motor adapted to convert a supplied AC electric energy to a rotational energy of an after-mentioned rotor and output the rotational energy to a motor output shaft. The vehicle-driving motor is provided with a motor torque controller for controlling a waveform (amplitude, frequency, phase) of a current to be supplied to the vehicle-driving motor, and a motor rotation angle sensor for detecting a rotation angle of a rotor of the vehicle-driving motor. The motor torque controller also serves as phase-angle setting means operable to set a current phase angle θ of the vehicle-driving motor.

The motor output shaft is mechanically connected to a drive axle and two road wheels through a differential unit (including reduction gear unit).

A current supply line in the first electric-power supply mode includes the matrix-converter line extending from the generator to the vehicle-driving motor through the matrix converter, and the bypass line adapted to bypass the matrix converter. The matrix-converter line is selected when there is a substantial waveform difference (i.e., difference in amplitude, frequency and/or phase) between a current waveform required for the vehicle-driving motor and a current waveform output from the generator, so as to eliminate the waveform difference through the matrix converter. The bypass line is selected when there is no substantial difference between the two current waveforms.

The second electric-power supply mode is configured such that, after converting an AC electric power from the generator, to a DC electric power through the inverter/converter, and storing the DC electric power in the battery, the DC electric power is discharged from the battery and converted to an AC electric power through the inverter/converter, and the AC electric power is supplied to the vehicle-driving motor through the matrix converter (i.e., the same mode as that in a conventional electric vehicle). The second electric-power supply mode is selected when the required output of the vehicle-driving motor is in a low output range (hereinafter referred to as “second driving range”) relative to the first driving range.

The required motor output determination section (serving as required motor output determination means) is adapted to determine a required output (including a required torque) of the vehicle-driving motor in conformity to a required vehicle driving force. The required vehicle driving force is determined based on the amount of driver's accelerator depression (including a change rate thereof) detected by and input from the accelerator depression amount sensor and the vehicle speed detected by and input from the vehicle speed sensor. For example, the required vehicle driving force may be determined by reading out a value from an experimentally-obtained and pre-stored correlation map of a required vehicle driving force and an accelerator depression amount/vehicle speed, with reference to the input accelerator depression amount and vehicle speed.

The required generator output determination section (serving as required generator output determination means) is adapted to determine a required output of the generator. Particularly in the first electric-power supply mode, a required output (AC electric power) of the generator is determined to have a current waveform conforming to that of a current required for the vehicle-driving motor to obtain a required motor output.

The required engine output determination section (required engine output determination means) is adapted to determine a required output (torque, rotation speed) of the engine in conformity to the required output of the generator. The rotation speed of the engine has a proportional relation to a frequency of an AC electric power generated by the generator. Thus, particularly in the first electric-power supply mode, the rotation speed of the engine (engine speed) is determined to have a value corresponding to the frequency of the required generator output.

The electric-power supply control section (serving as electric-power supply control means) is adapted to determine a current waveform of an AC electric power to be supplied to the vehicle-driving motor, in conformity to a required output of the vehicle-driving motor, and controllably determine a strategy of how to supply the AC electric power. Specifically, the electric-power supply control section is operable, when the required output of the vehicle-driving motor is in the first driving range, to supply the AC electric power in the first electric-power supply mode, and, when the required output of the vehicle-driving motor is in the second driving range, to supply the AC electric power in the second electric-power supply mode. Further, in the first electric-power supply mode, the electric-power supply control section is operable, when there is a substantial waveform difference between a current waveform required for the vehicle-driving motor and a current waveform output from the generator, to select the matrix-converter line, and, when there is no substantial waveform difference between the two current waveforms, to select the bypass line.

In certain embodiments, the hybrid vehicle drive control system is configured to perform engine startup when switching from an electric drive mode to a hybrid drive mode, without creating a sense of output torque loss.

### EXAMPLES

### Example 1

An Illustrative Vehicle of the Invention can Include the Following Components Among Others:

Enclosed cabin (or convertible), with windshield and windows

Operating windshield wipers and washers

There is an enclosed cabin with a windshield and windows.

The original windshield wipers and washer are unmodified and will be used.

Seat belts and head restraints—The original seats and seatbelt systems are unmodified and will be used.

Rear and side view mirrors—The original rear and side view mirrors are unmodified and will be used.

Fully functioning headlights, internal lighting, horn, indicators, speedometer, brake lights, and reflective devices. All of these systems have been unmodified and will be used in their original state.

Ground-Fault detection system for vehicles with high-voltage electrical system.

Emergency disconnect switch for vehicles with high-voltage electrical system

Inertia-switch disconnect system for vehicles with high-voltage electrical system.

Manual isolation switch for vehicles with high-voltage electrical system.

All of these systems are described in detail in section 3—“High Voltage ESS” and are detailed in the schematic in that section. These systems will be installed prior to the vehicle being road tested.

Feedback mechanisms to provide essential data to the driver (speed, fuel remaining, etc.)

The original cluster will be utilized in addition to an LCD display that is part of the control system. The cluster is pictured above.

Single control (e.g., foot pedal) for vehicle braking—The original brake pedal has not been modified and will be the single control for braking.

Parking brake capable of holding the vehicle's weight at rest on a 20% grade. The original parking brake meets this requirement and has been unmodified.

Single control for vehicle acceleration. The original throttle pedal has not been modified and will be the single control for acceleration.

Single control for directional steering commands—The original steering wheel has not been modified and will be the single control for steering (as pictured above).

All manual or automatic control systems (engine, braking, drive-train etc.) are contained on the vehicle and cannot be operated by remote (off-board) control.

All systems in the vehicle can only be controlled within the vehicle. It is outside our capacity to do otherwise.

Ground clearance of at least 4″ and data showing that the vehicle's approach and departure angles are sufficient to clear typical road-rated driveways and transporter ramps. The vehicle's ground clearance is approximately 6.5″. As a conversion vehicle, the Focus has been designed to meet the clearance requirements of driveways and transporter ramps.

### Example 2

Mainstream Class Vehicles Only

Capacity to carry 4 or more occupants (front passengers 95th percentile adult male, rear passengers 75th percentile adult male) Internal dimensions: front headroom (inches): 39.2, rear headroom (inches): 38.3, front hip room (inches): 50.4, rear hip room (inches): 48.3, front leg room (inches): 41.7, rear leg room (inches): 36.1, front shoulder room (inches): 53.4, rear shoulder room (inches): 53.6 and interior volume (cu ft): 93.4

10 cubic feet of useful, contiguous cargo space (when the vehicle has four occupants) sufficiently enclosed so that cargo is not a safety hazard during abrupt maneuvers. Cargo capacity: all seats in place (cu ft): 13.8 which is located in the trunk.

Minimum of two side-by-side front seats

The Focus has two side by side front seats as pictured above.

4 or more wheels—The hybrid vehicle has four wheels.

Heater

Air-conditioner

Audio system—The hybrid vehicle has all these systems as pictured above.

DOT approved tires with a minimum traction rating B and a tread wear rating 100 under the Uniform Tire

Quality Grading Standard (UTQGS), 49 CFR 575.104.

The currents tires (Hankook Optimo H725 P195/60R15) meet this standard. The tires will be replaced with a lower rolling resistant tire prior to the competition. The replacement tires have not been identified, but they will meet the specified requirements.

### Example 3

Feature Requirements

Enclosed cabin (or convertible), with windshield and windows

Operating windshield wipers and washers

The body has not been modified.

There is an enclosed cabin with a windshield and windows.

The original windshield wipers and washer are unmodified and will be used.

Seat belts and head restraints

The original Ford Focus seats and seatbelt systems are unmodified and will be used.

Rear and side view mirrors

The original vehicle rear and side view mirrors are unmodified and will be used.

Fully functioning headlights, internal lighting, horn, indicators, speedometer, brake lights, and reflective devices. All of these systems have been unmodified and will be used in their original state.

Ground-Fault detection system for vehicles with high-voltage electrical system.

Emergency disconnect switch for vehicles with high-voltage electrical system

Inertia-switch disconnect system for vehicles with high-voltage electrical system.

Manual isolation switch for vehicles with high-voltage electrical system.

All of these systems are described in detail in section 3—“High Voltage ESS” and are detailed in the schematic in that section. These systems will be installed prior to the vehicle being road tested.

Feedback mechanisms to provide essential data to the driver (speed, fuel remaining, etc.)

The original cluster will be utilized in addition to an LCD display that is part of the control system. The cluster is pictured above.

Single control (e.g., foot pedal) for vehicle braking

The original brake pedal has not been modified and will be the single control for braking.

Parking brake capable of holding the vehicle's weight at rest on a 20% grade.

The original parking brake meets this requirement and has been unmodified.

Single control for vehicle acceleration.

The original throttle pedal has not been modified and will be the single control for acceleration.

Single control for directional steering commands

The original steering wheel has not been modified and will be the single control for steering (as pictured above).

All manual or automatic control systems (engine, braking, drive-train etc.) are contained on the vehicle and cannot be operated by remote (off-board) control.

All systems in the vehicle can only be controlled within the vehicle.

Ground clearance of at least 4″ and data showing that the vehicle's approach and departure angles are sufficient to clear typical road-rated driveways and transporter ramps.

The vehicle's ground clearance is approximately 6.5″. As a conversion vehicle, the hybrid vehicle has been designed to meet the clearance requirements of driveways and transporter ramps.

Mainstream Class Vehicles Only

Capacity to carry 4 or more occupants (front passengers 95th percentile adult male, rear passengers 75th percentile adult male) Internal dimensions: front headroom (inches): 39.2, rear headroom (inches): 38.3, front hip room (inches): 50.4, rear hip room (inches): 48.3, front leg room (inches): 41.7, rear leg room (inches): 36.1, front shoulder room (inches): 53.4, rear shoulder room (inches): 53.6 and interior volume (cu ft): 93.4

10 cubic feet of useful, contiguous cargo space (when the vehicle has four occupants) sufficiently enclosed so that cargo is not a safety hazard during abrupt maneuvers.

Cargo capacity: all seats in place (cu ft): 13.8 which is located in the trunk.

Minimum of two side-by-side front seats

The vehicle has two side by side front seats as pictured above.

4 or more wheels

The Focus has four wheels as picture above.

Heater

Air-conditioner

Audio system

The Focus has all these systems as pictured above.

DOT approved tires with a minimum traction rating B and a tread wear rating 100 under the Uniform Tire

Quality Grading Standard (UTQGS), 49 CFR 575.104.

The currents tires (Hankook Optimo H725 P195/60R15) meet this standard. The tires will be replaced with a lower rolling resistant tire prior to the competition. The replacement tires have not been identified, but they will meet the specified requirements.

### Example Four

The EVX hybrid drive system was developed for a conversion of a 2008 Ford Focus to a charge-depleting plug-in hybrid vehicle. The design goal for this vehicle was to achieve 100 MPGe in combined fuel economy in a safe, cost-effective package while providing the performance expected in a typical sedan.

### Technology Description

The EVX hybrid drive system includes of an electric motor directly coupled to a manual transmission and an internal combustion (IC) engine. This novel innovation allows stock manual transmissions to be powered by two power sources—an electric motor and an IC engine. The advantage of this system is that it enables a typical manual transmission to operate as a hybrid being powered by both an electric motor and IC engine through a single transmission input shaft. The advantage of using a typical manual transmission is that it is cost effective, lightweight, and reliable especially when compared with complex, expensive planetary transmissions, CVT transmissions, and DSG transmissions. A typical manual transmission utilized in this way is an ideal transmission for a hybrid vehicle and makes this invention particularly compelling. In the prototype vehicle (see Figures), the stock Ford Focus transmission was utilized and powered by an Azure Dynamics electric motor and Harley Davidson engine. The basis for this configuration is a parallel plug-in hybrid (or range extended electric vehicle) where the electric motor is the primary drive motor and the IC engine provides additional power when needed. In the prototype vehicle, this system only utilized the IC engine for hard acceleration, highway driving and charging the batteries. Additionally, in the prototype, for low speed driving (40 mpg or less), the vehicle would only use the electric motor and operate in charge depleting mode.

Providing power from both the electric motor and IC engine to a single input shaft of the transmission is accomplished through a magnetic clutch that is controlled via the control system and a belt drive. The electric motor or IC engine can be directly coupled to the input shaft of the transmission while the belt drive connects the other engine/motor to the input shaft. (In the prototype vehicle, the electric motor and IC engine where both on the belt drive. However, this is only one possible configuration. The intended configuration is to have the IC engine directly coupled to the input shaft of the transmission through the magnetic clutch and the electric motor connected to the same input shaft via a belt drive).

The control system receives inputs from throttle position, vehicle speed sensor, and state of charge of the battery pack to determine which drive motor to utilize and in what percent. The control system (built on a programmable microcontroller) utilizes a Controller Area Network (CAN) interface to manage the electric drive, the magnetic clutch, and the throttle control for the IC engine. When the IC is on, the magnetic clutch is controlled by throttle position. For example, when there is zero throttle input, the clutch is open, and the engine free-wheels. To shift gears, the driver releases the throttle (zero input), shifts and then presses the throttle (this is the same sequence that all drivers utilize in a typically stick shift vehicle, however there is no need for a clutch pedal). The control system re-engages the magnetic clutch when the IC engine speed matches the electric motor engine speed. This control sequence removes the requirement of a clutch pedal and allows the drive to simply change gears by releasing the throttle pedal. Furthermore, this system lends itself to fully automating shifting the manual transmission. With the addition of an actuator on the gear selection input of the transmission, the control system effectively turns a simple, inexpensive, manual transmission into a highly efficient, automatic transmission.

The electric motor is also utilized as the starting motor for the IC engine. This novel innovation utilizes the cost effective, reliable, stock manual transmission to provide a robust, highly efficient hybrid drive system, which can be operated as a manual or automatic transmission.

### Simulation Results

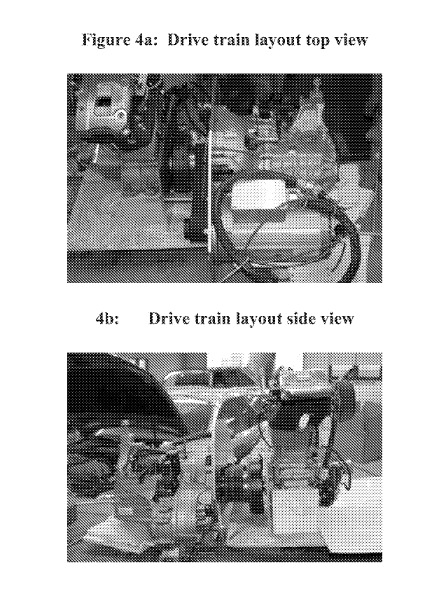

Using the Advisor AVL simulation software package, the vehicle's performance was simulated using the technical specifications of the Ford Focus chassis, Harley Davidson engine, and Azure Dynamics electric motor and controller. Using MATLAB's fuzzy logic toolbox, the control system of the car was modeled for use by Advisor. The electric mode simulation results, as seen in FIG. 4, used a US EPA federal test drive cycle. The test ran the vehicle for four miles with a maximum speed of 55 mph. This simulation displayed results of the car running on lithium-ion batteries alone, which achieved a fuel economy rating of 114.3 MPGe. The plot of zero emissions indicates that the ICE was not utilized during this test cycle.

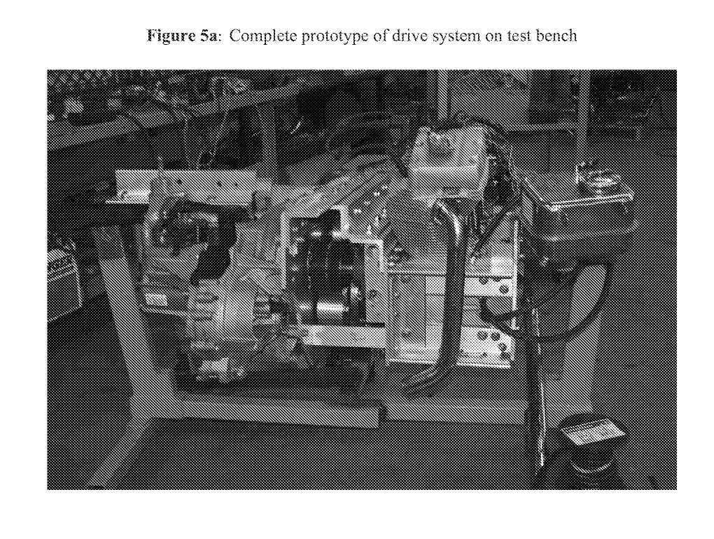

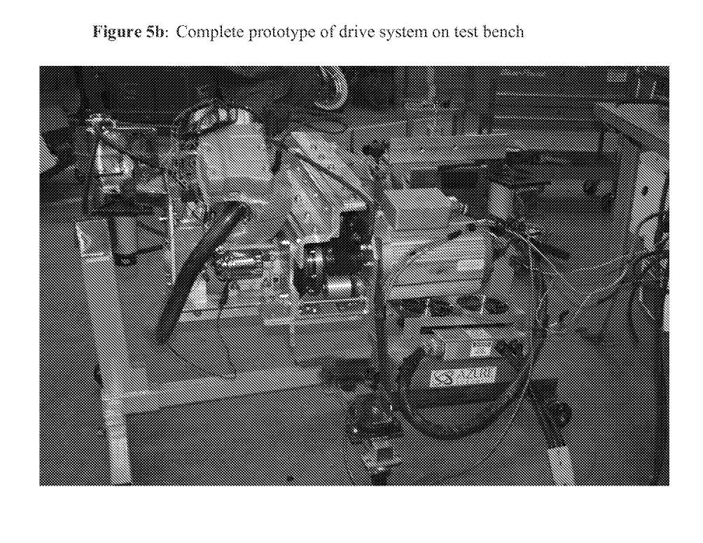

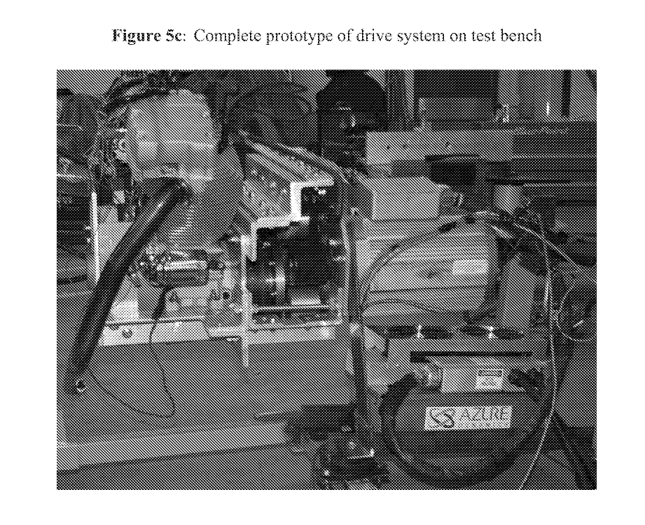

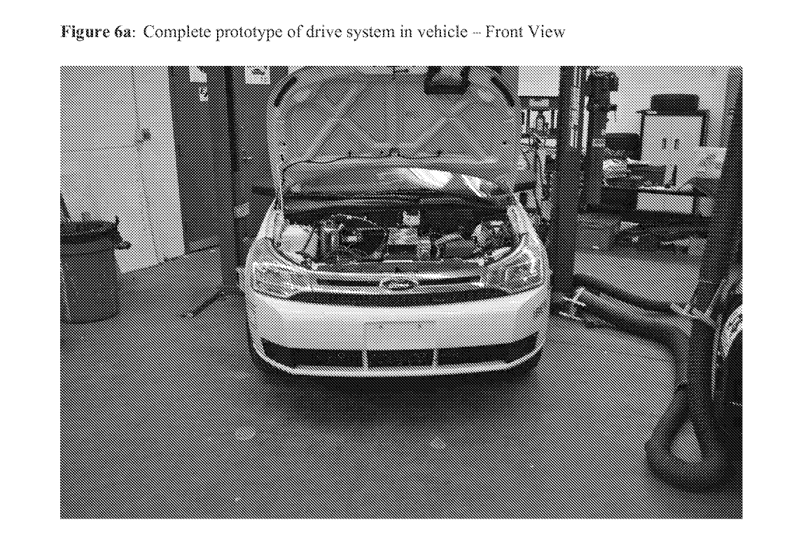

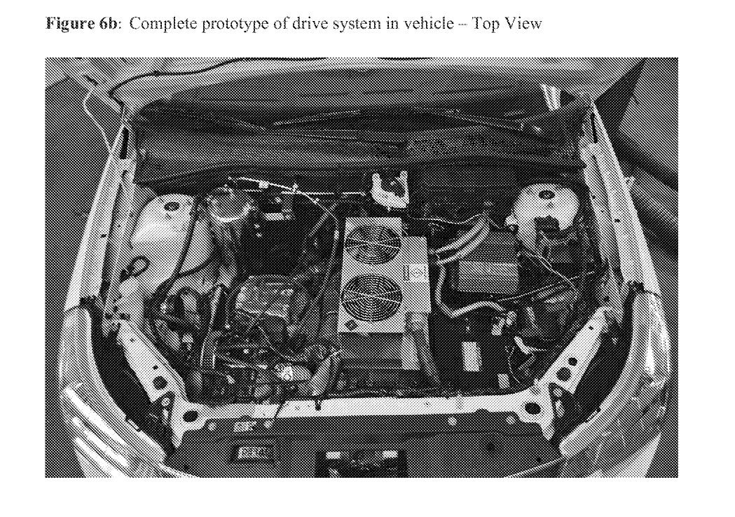

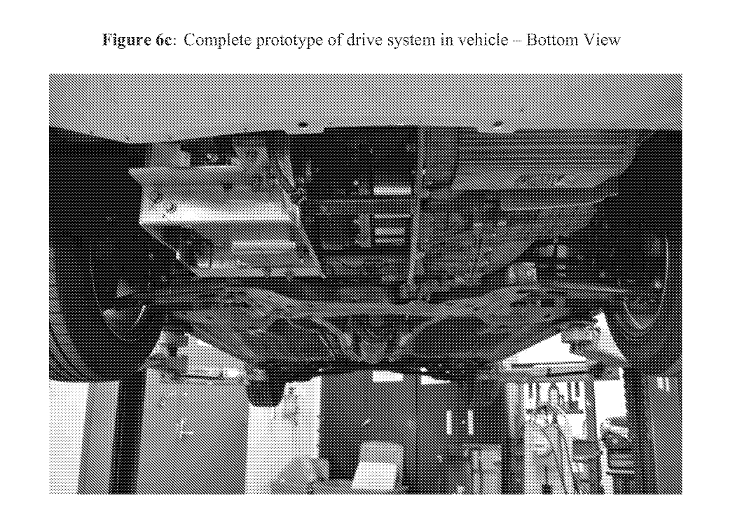

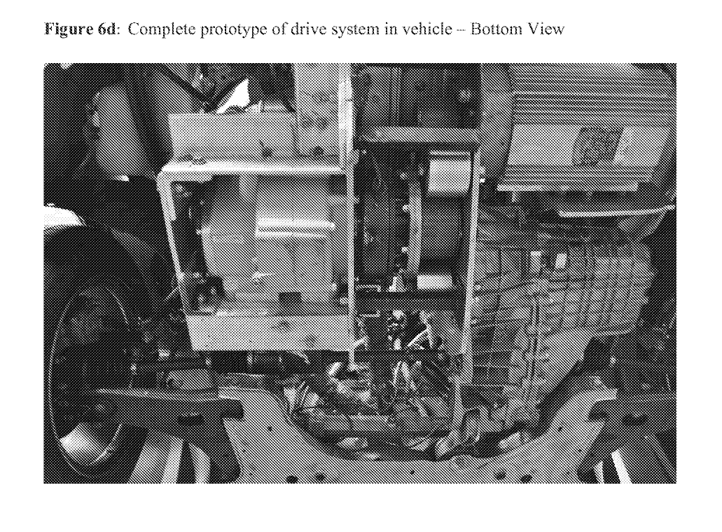

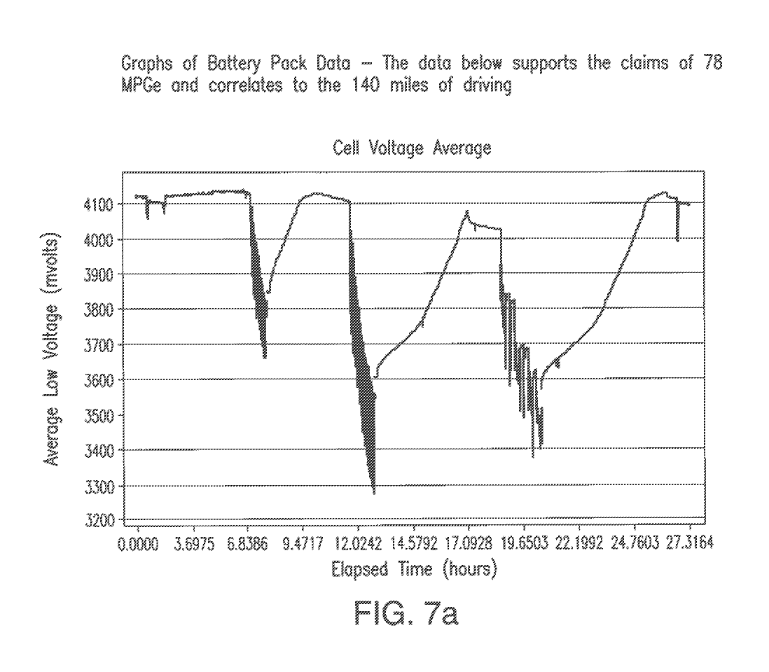

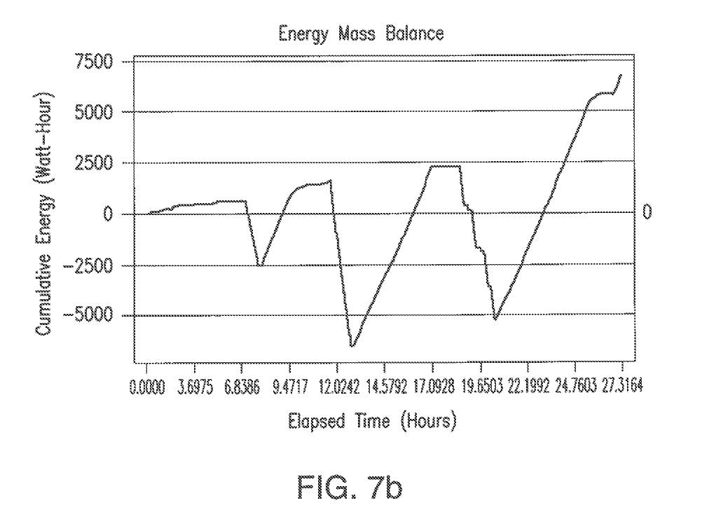

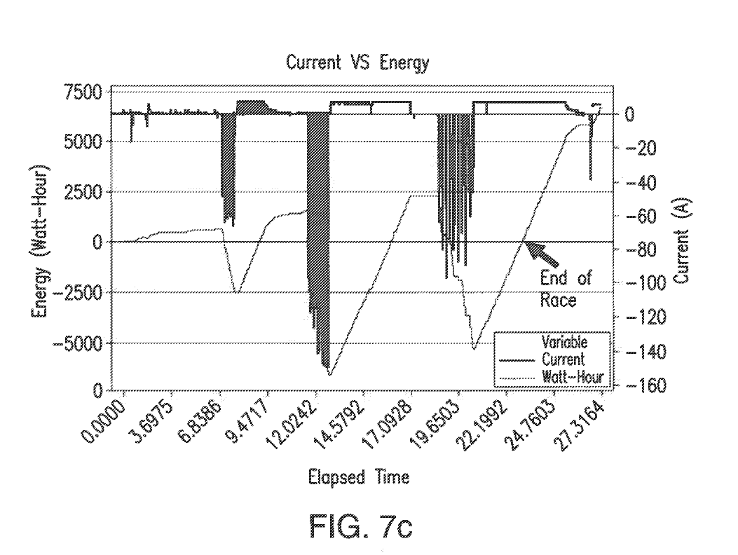

In addition to electric mode, the simulation tested efficiency mode in which the fuzzy logic control system dynamically decides the distribution of power between the two motors to allow the IC engine to operate at peak efficiency. The cycle used for this simulation was the US EPA Commuter cycle, in which the distance was 2.9 miles with a maximum speed of 55 mph. There was gradual acceleration which peaked and held a constant speed until it quickly decelerated. The simulation displayed favorable results of 77.1 MPGe, as seen in FIG. 5. The SOC plot shows how that the electric motor was being used while the emissions plot proves that the gasoline engine was also integrated into the simulation.

From the 136 original vehicles from around the world, the prototype vehicle utilizing the EVX hybrid drive system made it to the semi-final round along with only 21 other teams. It achieved 78 MPGe combined fuel economy over an aggressive 140 miles of city, urban, and highway drive cycles. The vehicle on average achieved 121 MPGe in city driving and 62 MPGe in highway driving. The drive cycle and duration of testing varied the results. The vehicle performed slightly below the anticipated results based on the Advisor Simulation. This was due mainly to the fact the drive cycles varied from the EPA drive cycle which was simulated in Advisor.

The initial configuration of the drive system had the IC engine directly coupled to the input shaft of the transmission through the magnetic clutch and the electric motor coupled through the belt drive. This is the optimal layout and required precise machining that was not available to the inventors at the time. This layout is shown in the CAD renderings and the initial layout pictured below.

The prototype system was built with both the electric motor and IC engine on the belt drive. This layout required less precise machining while accomplishing the same system level results.

In the specification, there have been disclosed typical illustrative embodiments of the invention and, although specific terms are employed, they are used in a generic and descriptive sense only and not for purposes of limitation. Obviously many modifications and variations of the invention are possible in light of the above teachings. It is therefore to be understood that the invention may be practiced otherwise than as specifically described.

Unless defined otherwise, all technical and scientific terms and any acronyms used herein have the same meanings as commonly understood by one of ordinary skill in the art in the field of this invention. Although any compositions, methods, kits, and means for communicating information similar or equivalent to those described herein can be used to practice this invention, the preferred compositions, methods, kits, and means for communicating information are described herein.

What is claimed is:

1. A hybrid drive system comprising an electric motor directly coupled to a manual transmission and an internal combustion (IC) engine, the manual transmission operates as a hybrid being powered by both an electric motor and IC engine through a single transmission input shaft, wherein the configuration is a parallel plug-in hybrid or range extended electric vehicle, where the electric motor is the primary drive motor and the IC engine provides additional power when needed.

2. A hybrid vehicle comprising: an electric motor, a combustion engine, a control and data acquisition system, and a battery operatively connected to the engine and motor and rechargeable using at least of said engine and said motor/generator, wherein the hybrid vehicle is a parallel plug-in gasoline-electric hybrid.

3. The hybrid vehicle of claim 2, wherein said powertrain strategy includes powering the vehicle with said engine, and includes one of homogenous charge compression ignition, port fuel injection, active fuel management, and direct injection strategy.

4. The hybrid vehicle of claim 2, wherein said powertrain strategy includes using at least one of ethanol, gasoline, dimethyl ether, and diesel fuel to run said engine.

5. The hybrid vehicle of claim 2, comprising magnetic clutch for hybrid drive.

6. A hybrid vehicle comprising an electric motor and plug-in technology for the batteries, comprising an electric drive as the primary drive unit, wherein a magnetic clutch allows control of the operation of the gas engine enabling automated shifting and the removal of the starter motor and alternator.

7. The hybrid vehicle of claim 6, wherein the control system allows for the electric motor and magnetic clutch to create driving parameters whereby a stock manual transmission can be automated.

8. The hybrid vehicle of claim 1, wherein the vehicle is a motorcycle, automobile, truck or ATV.
